(19) United States
(12) Patent Application Publication
(10) Pub. No.: US 2012/0088873 A1
(43) Pub. Date: Apr. 12, 2012

(54) POLYAMIDE MATERIAL HAVING HIGH FLUID BARRIER PROPERTIES

(75) Inventors: Caroll Vergelati, Sainte Baudille de la Tour (FR); Olivier Andres, Mions (FR); Ludovic Odoni, Rillieux la pape (FR); Didier Long, Sainte Foy Les Lyon (FR); Paul Sotta, Lyon (FR)

(73) Assignee: Rhodia Operations, Aubervillers (FR)

(21) Appl. No.: 13/260,265

(22) PCT Filed: Apr. 8, 2010
(86) PCT No.: PCT/EP10/54633

§ 371 Date: Nov. 16, 2011

(30) Foreign Application Priority Data
Apr. 10, 2009 (FR) 09 52395

(51) Int. Cl. C08L 77/06; C08J 3/20; C08L 61/10; C08K 5/435

(52) U.S. Cl. 524/169; 524/168

(57) ABSTRACT

Polyamide materials having high barrier properties to fluids, gases and liquids are described. These materials can especially be used for the manufacture of articles intended to contain or to transport a fluid such as, for example, pipes, ducts or tanks.

The present invention relates to polyamide materials having high fluid, gas and liquid barrier properties. These materials may in particular be used for the manufacture of articles intended to contain or to transport a fluid, such as, in particular, pipes, ducts or tanks.

### PRIOR ART

It is known from the prior art to use thermoplastic materials for the manufacture of single-layer or multilayer articles intended to contain or to transport a fluid, such as, for example, pipes, ducts or tanks.

However, it is often necessary to carry out improvements to these materials in order to give them satisfactory gas or liquid barrier properties.

It is, for example, known to use multilayer, in particular three-layer, pipes or tanks; it being possible for each layer to be made up of different materials in order to give the assembly the required barrier and mechanical properties depending on the applications. Mention may in particular be made of polyethylene-ethylene/vinyl alcohol copolymer-polyethylene multilayer articles, a compatibilization layer being used between each layer. However, such articles, in particular pipes, are expensive to produce, and the conversion of EVOH results in a need to clean the extruder, which tends to reduce the productivity of the manufacture of these articles. Furthermore, problems of delamination may occur between the incompatible materials of the various layers.

It is also known to use lamellar nanofillers in order to decrease the permeability of plastic matrices, in particular polyamide matrices. Such a decrease in permeability is attributed to a “tortuosity” effect caused by these nanofillers. The lamellar nanofillers which are most widely investigated today are clays of smectic type, mainly montmorillonite. However, it is difficult to use these products insofar as it is necessary to exfoliate them in the matrix in particular by using intercalation agents in order to obtain individual lamellae having a higher aspect ratio.

Thus, to date, solutions that are complex, difficult to implement and costly have been proposed in the prior art in order to increase the barrier properties of plastic materials; what is more, often at the expense of the other properties of the plastic materials, such as in particular the mechanical properties.

It is thus desirable to develop polyamide materials that make it possible to obtain effective levels of impermeability, while at the same time avoiding the drawbacks mentioned above.

### INVENTION

The applicant has demonstrated, quite surprisingly, that the use, in a polyamide matrix, of a novolac resin and of a sulfonamide compound makes it possible in particular to obtain a composition suitable for the manufacture of single-layer or multilayer articles having an excellent level of impermeability to gases and to liquids, in a simple manner and without negatively altering the other properties of said materials. The solution of the invention makes it possible not only to avoid the drawbacks known from the prior art, but also to obtain excellent fluid barrier properties, much higher than the systems used commercially. The polyamide materials of the invention also have good mechanical properties, such as, for example, a good modulus/impact balance, and/or a heat resistance enabling it to be handled and used at high temperatures.

The invention thus relates to a polyamide composition having in particular good fluid barrier properties, comprising at least one polyamide matrix, one novolac resin and one compound bearing at least one sulfonamide function.

The invention also relates to the use of a novolac resin and of a compound bearing at least one sulfonamide function, for the manufacture of a polyamide composition having good fluid barrier properties.

The expression “compositions or materials having high fluid barrier properties” is intended to mean a composition or material which has a reduced permeability with respect to a fluid. According to the present invention, the fluid may be a gas or a liquid. As gases, mention may in particular be made of oxygen, carbon dioxide, light hydrocarbons, such as ethane, propane, ethylene and propylene, and water vapor. As liquids, mention may be made of apolar solvents, in particular the representative solvents of gasolines, such as toluene or isooctane, and/or polar solvents, such as water and alcohols, and coolants. It should be noted that the liquids may have variable viscosities, such as, in particular, the high-viscosity liquids that are similar to gels or creams.

As a polyamide according to the invention, mention may be made of semicrystalline or amorphous polyamides and copolyamides, such as aliphatic polyamides, semi-aromatic polyamides and, more generally, linear polyamides obtained by polycondensation between an aliphatic or aromatic saturated diacid and an aromatic or aliphatic saturated primary diamine, the polyamides obtained by condensation of a lactam, or of an amino acid, or the linear polyamides obtained by condensation of a mixture of these various monomers. More specifically, these polyamides may be, for example, polyhexamethylene adipamide, polyphthalamides obtained from terephthalic acid and/or isophthalic acid, and the copolyamides obtained from adipic acid, from hexamethylenediamine and from caprolactam.

According to one preferential embodiment of the invention, the polyamide matrix comprises at least one polyamide selected from the group consisting of the polyamide PA 6, the polyamide PA 66, the polyamide PA 10, the polyamide PA 11, the polyamide PA 12, poly(meta-xylylenediamine) (MXD6), and the blends and copolymers based on these polyamides.

The polyamide is preferentially selected from the group consisting of the polyamides obtained by polycondensation of a linear dicarboxylic acid with a linear or cyclic diamine, such as PA 6,6, PA 6,10, PA 6,12, PA 12,12, PA 4,6 or MXD6, or between an aromatic dicarboxylic acid and a linear or aromatic diamine, such as polyterephthalamides, polyisophthalamides or polyaramids, and the polyamides obtained by polycondensation of an amino acid to itself, the amino acid possibly being generated by hydrolytic opening of a lactam ring, such as, for example, PA 6, PA 7, PA 11 or PA 12.

The composition of the invention may also comprise the copolyamides derived in particular from the above polyamides, or the blends of these polyamides or copolyamides.

The preferred polyamides are polyhexamethylene adipamide, polycaprolactam, or copolymers and blends of polyhexamethylene adipamide and polycaprolactam.

Use is generally made of polyamides having molecular weights suitable for injection-molding processes, although it is possible to also use polyamides of lower viscosities.

The polyamide matrix may in particular be a polymer comprising star or H-shaped macromolecular chains, and where appropriate, linear macromolecular chains. The polymers comprising such star or H-shaped macromolecular chains are, for example, described in documents FR2743077, FR2779730, U.S. Pat. No. 5,959,069, EP0632703, EP0682057 and EP0832149.

According to another particular variant of the invention, the polyamide matrix of the invention may be a polymer of random tree type, preferably a copolyamide having a random tree structure. These copolyamides of random tree structure and also the method for obtaining them are in particular described in document WO 99/03909. The matrix of the invention may also be a composition comprising a linear thermoplastic polymer and a star, H-shaped and/or tree thermoplastic polymer as described above. The matrix of the invention may also comprise a hyperbranched copolyamide of the type of those described in document WO 00/68298. The composition of the invention may also comprise any combination of linear, star, H-shaped, tree thermoplastic polymer or hyperbranched copolyamide as described above.

The composition according to the invention preferentially has from 30 to 95% by weight of polyamide, preferentially from 40 to 80% by weight, relative to the total weight of the composition.

The novolac resins are generally products of condensation of phenolic compounds with aldehydes or ketones. These condensation reactions are generally catalyzed by an acid or a base.

The polyamide according to the invention may comprise one or more different types of novolac resin.

The novolac resins generally have a degree of condensation of between 2 and 15.

The phenolic compounds may be selected, alone or as a mixture, from phenol, cresol, xylenol, naphthol, alkylphenols, such as butylphenol, tert-butylphenol or isooctylphenol, nitrophenol, phenylphenol, resorcinol or bisphenol A; or any other substituted phenol.

The aldehyde most commonly used is formaldehyde. Use may, however, be made of others, such as acetaldehyde, para-formaldehyde, butyraldehyde, crotonaldehyde, glycoxal and furfural.

As a ketone, use may be made of acetone, methyl ethyl ketone or acetophenone.

According to one particular embodiment of the invention, the novolac resin is a product of condensation of phenol and formaldehyde.

The novolac resins used advantageously have a high molecular weight between 500 and 3000 g/mol, preferably between 800 and 2000 g/mol.

As commercial novolac resin, mention may in particular be made of the commercial products Durez®, Vulkadur® or Rhenosin®.

The composition according to the invention may comprise between 0.1 and 20% by weight of novolac resin, in particular from 1 to 15% by weight, particularly from 5 to 10% by weight, or proportions between these values, relative to the total weight of the composition.

The compounds bearing at least one sulfonamide function are generally known for their plasticizing effect on the polyamide.

The polyamide composition may comprise one or more compounds bearing at least one sulfonamide function.

The compound bearing at least one sulfonamide function may in particular comprise one or two sulfonamide function(s).

The compound bearing a sulfonamide function may in particular be represented by general formula (I)

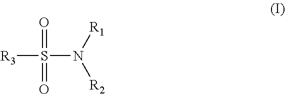

in which R₁ and R₂ are, independently of one another, a hydrogen atom or a hydrocarbon-based chain containing from 1 to 20 carbon atoms optionally comprising heteroatoms, and R₃ corresponds to a hydrocarbon-based chain containing from 1 to 20 carbon atoms optionally comprising heteroatoms.

The compound bearing a sulfonamide function is in particular a benzenesulfonamide in which the R3 group is an optionally substituted benzene.

For the purpose of the invention, the expression “hydrocarbon-based chain possibly comprising heteroatoms” is intended to mean a linear or branched, cyclic or noncyclic, saturated or unsaturated chain.

The R₁ and R₂ and R₃ functions, independently of one another, can correspond to a linear or nonlinear alkyl containing from 1 to 20 carbon atoms, a saturated or unsaturated cyclic group containing from 3 to 6 carbon atoms, which is optionally substituted, an alkylallyl or an allylalkyl. As radicals, mention may be made of methyl, ethyl, propyl, butyl, hexyl, tert-butyl, dodecyl and octadecyl groups.

The sulfonamide compound of the invention may in particular be a disulfonamide. In this case, the compound R₁ or R₂ bears a sulfonamide function.

By way of example, the sulfonamide compound of the invention of disulfonamide type can be represented by formula (II):

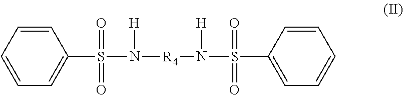

in which R₄ is a divalent group containing from 1 to 20 carbon atoms optionally comprising heteroatoms. This divalent group may be a linear or branched, cyclic or noncyclic, saturated or unsaturated chain. Mention may in particular be made of ethyl, butyl, n-butyl, trimethyl, octyl, decyl, n-decyl and xylyl groups.

The compounds of formula (I) which are preferred are, for example, selected from the group consisting of: benzenesulfonamide (BSA), N,N-dimethylbenzenesulfonamide (DMBSA), N-methylbenzenesulfonamide (MBSA), N-(ethyl)benzenesulfonamide (EBSA), N-(n-butyl)benzene-sulfonamide (BBSA), N-(n-dodecyl)benzenesulfonamide (DoBSA), N-(tert-dodecyl)benzenesulfonamide (TDoBSA), N-(n-octadecyl)benzenesulfonamide (OdBSA) and N-(n-butyl)-N-(n-dodecyl)benzenesulfonamide (BDBSA).

The compounds of formula (II) which are preferred are, for example, selected from the group consisting of: N,N′-bis(ethylbenzenesulfonamide) (bisEBSA), N,N′-bis(n-butylbenzenesulfonamide) (bisBBSA), N,N′-bis(n-hexylbenzenesulfonamide) (bisHBSA), N,N′-bis(trimethyl-hexylbenzenesulfonamide) (bisTMHBSA), N,N′-bis(n-octylbenzenesulfonamide) (bisOBSA), N,N′-bis(n-decylbenzenesulfonamide) (bisDBSA), N,N′-bis(n-dodecylbenzenesulfonamide) (bisDoBSA) and N,N′-bis(1,3-xylylbenzenesulfonamide) (bisXBSA).

The composition according to the invention may also comprise between 0.1 and 10% by weight of sulfonamide compound, for example of formula (I) or of formula (II), especially from 1 to 5% by weight, particularly from 2 to 3% by weight, or proportions between these values, relative to the total weight of the composition.

Preference is particularly given to the polyamide compositions comprising:
from 30 to 90% by weight of polyamide,
from 1 to 15% by weight of novolac resin,
from 1 to 5% by weight of compound of formula (I) or (II), and
optionally, reinforcing or bulking fillers and/or impact modifiers, and
optionally, various additives;

the percentages by weight are expressed relative to the total weight of the composition.

The material or composition of the invention may also comprise other compounds or additives generally used in compositions based on a plastic matrix, such as, for example: reinforcing or bulking fillers, heat stabilizers, nucleating agents, plasticizers, flame retardants, antioxidants, UV stabilizers, colorants, optical brighteners, lubricants, anti-blocking agents, mattifying agents such as titanium oxide, processing aids, elastomers, adhesion agents, dispersants, pigments, impact modifiers, active oxygen scavengers or absorbers, and/or catalysts.

The composition of the invention may in particular comprise reinforcing or bulking fillers selected from the group consisting of fibrous fillers such as glass fibers, aramid fibers and carbon fibers; or mineral fillers, such as aluminosilicate clays, kaolin, wollastonites, talcs, calcium carbonates, fluoromicas, calcium phosphates and derivatives. The weight concentration of the reinforcing or bulking fillers is advantageously between 1% and 50% by weight, relative to the total weight of the composition, preferably between 15 and 50%.

There is no limitation on the types of impact modifiers. These are generally polymers of elastomers which can be used for this purpose. Resilience modifiers are generally defined as having an ASTM D-638 tensile modulus of less than approximately 500 MPa. Examples of suitable elastomers are ethylene/acrylic ester/maleic anhydride, ethylene/propylene/maleic anhydride, EPDM (ethylene/propylene/diene monomer) optionally with a grafted maleic anhydride. The weight concentration of elastomer is advantageously between 0.1 and 30% relative to the total weight of the composition.

Impact modifiers comprising functional groups that are reactive with the polyamide are in particular preferred. Mention may, for example, be made of terpolymers of ethylene, acrylic ester and glycidyl methacrylate, copolymers of ethylene and butyl ester acrylate, copolymers of ethylene, n-butyl acrylate and glycidyl methacrylate, copolymers of ethylene and maleic anhydride, styrene/maleimide copolymers grafted with maleic anhydride, styrene/ethylene/butylene/styrene copolymers modified with maleic anhydride, maleic anhydride-grafted styrene/acrylonitrile copolymers, maleic anhydride-grafted acrylonitrile/butadiene/styrene copolymers, and their hydrogenated versions. The proportion by weight of these agents in the total composition is in particular between 0.1 and 40%.

The materials and compositions of the invention are generally obtained by hot-blending the various constituents, for example in a single-screw or twin-screw extruder, at a sufficient temperature to keep the polyamide resin in the melt state; or cold-blended in a mechanical mixer in particular. Generally, the blend obtained is extruded in the form of rods which are cut into pieces in order to form granules. The novolac resin and the sulfonamide compound may be added at any moment of the process for manufacturing the plastic material, in particular by hot- or cold-blending with the plastic matrix.

The addition of the compounds and additives, such as the novolac resin, may be carried out by adding these compounds to the molten plastic matrix in pure form or in the form of a concentrated blend in a matrix such as, for example, a plastic matrix.

The granules obtained are then used as raw material for feeding the processes for manufacturing articles, such as injection-molding, extrusion or extrusion-blow molding processes.

The invention also relates to the articles obtained by forming the composition of the invention, by any plastic conversion technique, for instance by extrusion, such as, for example, extrusion of foils and films or extrusion-blow molding; by molding, such as, for example, compression molding, molding by thermoforming or rotomolding; by injection, such as, for example, by injection molding or by injection-blow molding.

The invention relates quite particularly to articles of the type of those that contain or that transport a fluid, comprising at least one part based on a composition as described above. These are therefore generally hollow bodies or packaging films and articles. These articles are in particular selected from the group consisting of: tanks, containers, vats, bottles, boxes, pipes, hoses, ducts, pump components, or derivatives.

The composition or material according to the present invention may be deposited or combined with another substrate, such as plastic materials for the manufacture of composite, in particular multilayer, articles.

A specific language is used in the description so as to facilitate the understanding of the principle of the invention. It should nevertheless be understood that no limitation of the scope of the invention is envisioned through the use of this specific language. Modifications, improvements and optimization can in particular be envisioned by a person familiar with the technical field concerned, on the basis of their own general knowledge. The term “and/or” includes the meanings “and” and “or” and also all the other possible combinations of the components connected with this term. Other details or advantages of the invention will appear more clearly in the light of the examples given below solely by way of indication.

### Experimental Section

### EXAMPLE 1

### Preparation of the Compositions and Articles

Compositions based on polyamide (PA 66 27AD1 from the company Rhodia, having a VN of 140 ml/g according to standard ISO 307) are obtained by extrusion on a Leistritz LSM 30/34 co-rotating twin-screw extruder, by adding variable amounts of BBSA (supplier Aldrich) and of novolac resin (Rhenosin PR95 distributed by the company Lanxess).

The processing characteristics are the following: Leistritz LSM 30/34 co-rotating twin-screw extruder, with
a temperature profile: 250-265-260-269-272-270-270-271-270-275° C.
screw speed (rpm): 250
motor force (N.m): 12
pressure: 20 bar

Multipurpose test specimens and sheets are prepared by injection molding in the following way: Billion 140T injection press, screw 45 mm in diameter and 900 mm in length.

T(° C.) barrel: 275 (test specimens), 280 (sheets)

T(° C.) mold: 80 (for test specimens and sheets)

Injection speed (m/s): 25 (test specimens), 170 (sheets)

Injection pressure (bar): 44 (test specimens), 1480 (sheets)

Hold pressure (bar): 40 (test specimens), 300 (sheets)

Back pressure (bar): 5 (test specimens), 50 (sheets)

Screw speed (rpm): 150 (test specimens), 200 (sheets)

Films of the various compositions are directly processed on leaving the extruder. A special die, called a sheet die, is fitted onto the converging section. Said die makes it possible to make the extruded material into the form of a sheet 300 mm wide and about 10 microns to 1 mm thick, this thickness being manually adjustable over the entire width of the die by means of a screw.

The cooling tank normally used during a “conventional” extrusion is replaced with the film dispenser composed of:
two Chill-Rolls: temperature-regulated rolls which allow more or less rapid cooling of the film,
six “support” rolls which simply guide the film,
a double drive roll, the tension and speed of which can be regulated,
a winding roll, the torque of which can be regulated and on which the final product is stored,
a compressed air feed at the outlet of the sheet die for controlling the cooling of the film.

### EXAMPLE 2

### Measurement of Properties

The dimensional variability properties of the various compositions were measured on sheets. The mechanical properties of the various compositions were measured on multi-purpose test specimens. The barrier properties against the diffusion of entities of the various compositions were measured on films.

The dimensional variability measurements are carried out for all the compositions using rectangular sheets having dimensions of 100×100×2.3 mm³. It is a question of determining the average change in the dimensions of the sheet in the direction parallel to the material flow and in the direction perpendicular to the material flow between a “dry” state (direct after molding) and an equilibrium state corresponding to storage under RH50 conditioning (degree of hygrometry of 50%) at a temperature of 23° C.

For all the compositions, the tensile, Young's modulus, yield stress and strain measurements are carried out according to standard ISO 527.

The permeability tests are produced in order to evaluate the capacity of the various compositions to prevent the diffusion of solvents or of a mixture of solvents. The principle consists in depositing a square of film of 50×50×0.15 mm³ on a cell containing a certain amount of solvent (pure ethanol in the present case). The film closes the cell after four screws have been tightened. The cell is weighed at regular time intervals in order to follow the change in the loss of mass. The measurement can be carried out under a hood at ambient temperature and ambient RH, or in an incubator at controlled temperature and controlled RH: 40° C. and RH0 in the present case. The value of the slope of the line obtained by following the change in loss of mass as a function of time is that of the intrinsic diffusion coefficient of the molecule studied in the composition under consideration, under the redefined temperature and hygrometry conditions.

The comparison in terms of dimensional stability properties (dimensional variability in the parallel (//) and perpendicular (⊥) direction after RH50-23° C. conditioning), tensile mechanical properties (Young's modulus) and barrier properties (diffusion coefficient of ethanol at 40° C. and RH0) of the pre-detailed compositions is reported in the following table 1:

The compositions obtained are the following:

C1: Polyamide PA 6,6 control (non additivated)

1: Polyamide PA 6,6 additivated with 6% by weight of a conventional phenol-formaldehyde (novolac) resin (Rhenosin PR95) and 2% by weight of BBSA

C2: Polyamide PA 6,6 additivated with 6% by weight of a conventional phenol-formaldehyde (novolac) resin (Rhenosin PR95)

C3: Polyamide PA 6,6 additivated with 2% by weight of BBSA

TABLE 1

| | | | | | Tension | | Barrier | |
|---|---|---|---|---|---|---|---|---|
| | Dimensional stability | | | | strength | | properties | |
| | | Gain | | Gain | | Gain | | Gain |
| | | (+) | | (+) | | (+) | Ethanol | (+) |
| | | Loss | | Loss | Young's | Loss | diffusion | Loss |
| | ΔL// | (−) | ΔL ⊥ | (−) | M | (−) | coeff. | (−) |
| | (mm) | (%) | (mm) | (%) | (MPa) | (%) | (g/m² · d) | (%) |
| C1 | 0.339 | — | 0.308 | — | 2497 | — | 108 | — |
| 1 | 0.181 | +46.6 | 0.169 | +45.1 | 2854 | +14.3 | 56 | +48.1 |
| C2 | 0.145 | +55.7 | 0.113 | +63.3 | 2685 | +7.5 | 84 | +22.2 |
| C3 | 0.345 | −1.8 | 0.338 | −9.7 | 2494 | −0.1 | 128 | −18.5 |

It is thus observed that composition 1 of the invention exhibits much better barrier properties than the prior art compositions while at the same time maintaining a very good balance between mechanical properties and dimensional stabilities linked to the low water uptake.

1. A polyamide composition having fluid barrier properties, the composition comprising at least one polyamide matrix, one novolac resin and one compound bearing at least one sulfonamide function.

2. The composition as claimed in claim 1, wherein the polyamide matrix comprises at least one polyamide selected from the group consisting of polyamide PA 6, polyamide PA 66, polyamide PA 10, polyamide PA 11, polyamide PA 12, MXD6, and blends and copolymers based on these polyamides.

3. The composition as claimed in claim 1, wherein the composition comprises from 30% to 95% by weight of polyamide, relative to the total weight of the composition.

4. The composition as claimed in claim 1, wherein the novolac resin is a product of condensation of phenol and formaldehyde.

5. The composition as claimed in claim 1, wherein the polyamide composition comprises between 0.1% and 20% by weight of novolac resin, relative to the total weight of the composition.

6. The composition as claimed in claim 1, wherein the compound bearing at least one sulfonamide function comprises one or two sulfonamide function(s).

7. The composition as claimed in claim 1, wherein the compound bearing a sulfonamide function is represented by general formula (I) 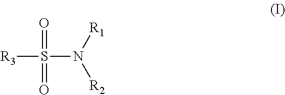
in which R₁ and R₂ are, independently of one another, a hydrogen atom or a hydrocarbon-based chain containing from 1 to 20 carbon atoms optionally comprising heteroatoms, and R₃ corresponding to a hydrocarbon-based chain containing from 1 to 20 carbon atoms optionally comprising heteroatoms.

8. The composition as claimed in claim 7, wherein the R₁, R₂ and R₃ functions, independently of one another, correspond to a linear or nonlinear alkyl comprising 1 to 20 carbon atoms, a saturated or unsaturated cyclic group comprising 3 to 6 carbon atoms, which is optionally substituted, an alkylallyl or an allylalkyl.

9. The composition as claimed in claim 1, wherein the sulfonamide compound is represented by formula (II): 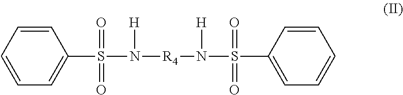
in which R₄ is a divalent group comprising 1 to 20 carbon atoms optionally comprising heteroatoms.

10. The composition as claimed in claim 7, wherein the compound of formula (I) is selected from the group consisting of: benzenesulfonamide, N,N-dimethylbenzenesulfonamide, N-methylbenzenesulfonamide, N-(ethyl)benzenesulfonamide, N-(n-butyl)benzenesulfonamide, N-(n-dodecyl)benzenesulfonamide, N-(tert-dodecyl)benzenesulfonamide, N-(n-octadecyl)benzenesulfonamide and N-(n-butyl)-N-(n-dodecyl)benzenesulfonamide.

11. The composition as claimed in claim 9, wherein the compound of formula (II) is selected from the group consisting of: N,N′-bis(ethylbenzenesulfonamide), N,N′-bis(n-butylbenzenesulfonamide), N,N′-bis(n-hexylbenzenesulfonamide), N,N′-bis(trimethylhexylbenzenesulfonamide), N,N′-bis(n-octylbenzenesulfonamide), N,N′-bis(n-decylbenzenesulfonamide), N,N′-bis(n-dodecylbenzenesulfonamide) and N,N′-bis(1,3-xylylbenzenesulfonamide).

12. The composition as claimed in claim 1, wherein the composition comprises between 0.1% and 10% by weight of sulfonamide compound, relative to the total weight of the composition.

13. The composition as claimed in claim 1, wherein said composition comprises at least:
from 30% to 90% by weight of polyamide,
from 1 to 15% by weight of novolac resin,
from 1% to 5% by weight of compound of formula (I) or (II), and
optionally, reinforcing or bulking fillers, and/or impact modifiers, and
optionally, various additives;
wherein the percentages by weight are expressed relative to the total weight of the composition.

14. A method of manufacturing a polyamide composition, the method comprising manufacturing the polyamide with a novolac resin and a compound bearing at least one sulfonamide function, so that the polyamide composition exhibits fluid barrier properties.
